(19) United States
(12) Patent Application Publication
(10) Pub. No.: US 2026/0141843 A1
(43) Pub. Date: May 21, 2026

(54) DISPLAY PANEL AND DISPLAY DEVICE INCLUDING THE SAME

(71) Applicant: LG Display Co., Ltd., Seoul (KR)

(72) Inventors: Min June JANG, Paju-si (KR); Mi Young SON, Paju-si (KR)

(73) Assignee: LG Display Co., Ltd., Seoul (KR)

(21) Appl. No.: 19/310,727

(22) Filed: Aug. 26, 2025

(30) Foreign Application Priority Data
Nov. 15, 2024 (KR) 10-2024-0163131

(51) Int. Cl. G09G 3/32; G09G 3/3266; G09G 3/3275

(52) U.S. Cl. CPC G09G 3/32; G09G 3/3266; G09G 3/3275; G09G 2300/0426; G09G 2310/0267; G09G 2310/0275; G09G 2310/08

(57) ABSTRACT

Disclosed are a display panel and a display device including the same. The display panel includes: a first power pad, a second power pad, and a third power pad configured to receive a first driving voltage; a first wire connected to the first power pad; a second wire connected to the second power pad; a third wire connected to the third power pad; at least one transistor connected to the first wire; at least one transistor connected to the second wire; and at least one transistor connected to the third wire. The first wire, the second wire, and the third wire have the same length.

### CROSS-REFERENCE TO RELATED APPLICATION

This application claims priority to and the benefit of Korean Patent Application No. 10-2024-0163131, filed Nov. 15, 2024, the disclosure of which is incorporated herein by reference in its entirety.

### BACKGROUND

### Field

The present disclosure relates to a display panel and a display device including the same.

### Discussion of Related Art

A display device is applied to various electronic devices such as a television, a mobile phone, a laptop, and a tablet. The display device includes an organic light emitting display device (OLED) that emits light by itself, and a liquid crystal display device (LCD) that requires a separate light source.

Recently, a display device including a light emitting diode (LED) has gained attention as a next-generation display device. Since the light emitting diode is formed of an inorganic material rather than an organic material, it provides faster lighting speed, superior luminous efficiency, and the capability to display high-luminance images, compared to the liquid crystal display device or the organic light emitting display device.

The display device may include a plurality of sub-pixels arranged in a panel, and various circuits for driving the plurality of sub-pixels. For example, the display device may include a gate driving circuit that controls the driving timing of the plurality of sub-pixels, and a data driving circuit that supplies data voltages corresponding to image data to the plurality of sub-pixels.

The gate driving circuit may be configured with a plurality of switches and wires to supply gate pulses to a plurality of gate lines. The gate driving circuit may be directly formed on the same substrate together with the sub-pixels of the display panel. When the gate driving circuit is formed together with the sub-pixels, compared to when it is positioned in a bezel region of the display device, there may be a great number of wires that need to be added and/or formed. As the types of such wires become more diverse and complicated, the wire length may increase, which can cause a problem of deteriorating output characteristics of the gate driving circuit.

### SUMMARY

An object of the present disclosure is to solve the above-described needs and/or problems associated with the related art.

The objectives of the present disclosure are not limited to those mentioned above, and other objectives not explicitly mentioned can be clearly understood by those skilled in the art from the following description.

A display panel according to one or more example embodiments of the present disclosure includes: a first power pad, a second power pad, and a third power pad to which a first driving voltage is applied; a first wire connected to the first power pad; a second wire connected to the second power pad; a third wire connected to the third power pad; at least one transistor connected to the first wire; at least one transistor connected to the second wire; and at least one transistor connected to the third wire. The first wire, the second wire, and the third wire have the same length.

The display panel may further include a plurality of sub-pixel circuits. The at least one transistor connected to the first wire, the at least one transistor connected to the second wire, and the at least one transistor connected to the third wire are each positioned between adjacent sub-pixel circuits in a first direction of the display panel.

The display panel may further include gate wires connected to the sub-pixel circuits, and a gate driving circuit connected to the gate wires and configured to supply an emission signal to the gate wires. The gate driving circuit may include the at least one transistor connected to the first wire, the at least one transistor connected to the second wire, and the at least one transistor connected to the third wire.

The at least one transistor connected to the first wire may include a feed transistor having a first electrode, a gate electrode connected to an output terminal of the emission signal, and a second electrode connected to a first driving voltage wire to which the first driving voltage is applied.

The at least one transistor connected to the first wire may be connected to an inverter of the gate driving circuit.

The inverter may include a fourth transistor, a fifth transistor, and a sixth transistor. The fourth transistor may have a first electrode, a gate electrode, and a second electrode connected to the first driving voltage wire. The fifth transistor may have a first electrode connected to the gate electrode of the fourth transistor, and a gate electrode and a second electrode connected to the first driving voltage wire.

The at least one transistor connected to the third wire may include a first pull-up transistor of the gate driving circuit. The at least one transistor connected to the second wire may include a second pull-up transistor of the gate driving circuit. Each of the first and second pull-up transistors may have a first electrode connected to an output terminal from which the emission signal is outputted, a gate electrode connected to a Q node, and a second electrode connected to the first driving voltage wire.

The display panel may further include a plurality of data pads to which a data signal is applied. Each of the first power pad, the second power pad, and the third power pad is positioned between adjacent data pads in a first direction of the display panel.

In another aspect, a display device according to one or more example embodiments of the present disclosure includes: a display panel having a pad area including a first power pad, a second power pad, and a third power pad, a first wire connected to the first power pad, a second wire connected to the second power pad, a third wire connected to the third power pad, at least one transistor connected to the first wire, at least one transistor connected to the second wire, and at least one transistor connected to the third wire; and a circuit configured to supply a first driving voltage to the first power pad, the second power pad, and the third power pad. The first wire, the second wire, and the third wire have the same length.

According to example embodiments of the present disclosure, the wire length may be reduced, thereby improving the output characteristics of the gate driving circuit. Accordingly, the operational reliability of the display device may be enhanced, and low-power driving may be achieved.

According to example embodiments of the present disclosure, resistance caused by an increase in wire length may be reduced. This may stabilize the output of the gate driving circuit.

It is to be understood that both the foregoing general description and the following detailed description are by way of example and are intended to provide further explanation of the inventive concepts as claimed.

### BRIEF DESCRIPTION OF THE DRAWINGS

The accompanying drawings, which are included to provide a further understanding of the present disclosure and are incorporated in and constitute a part of this application, illustrate example embodiments of the present disclosure and together with the description serve to explain various principles of the disclosure. In the drawings:

FIG. 1 is a schematic configuration diagram of a display device according to an example embodiment of the present disclosure;

FIG. 2 is a schematic plan view of a display panel included in a display device according to an example embodiment of the present disclosure;

FIG. 3 is a plan view of a unit pixel area included in a display device according to an example embodiment of the present disclosure;

FIG. 4 is a circuit diagram of a sub-pixel included in a display device according to an example embodiment of the present disclosure;

FIG. 5 is a diagram illustrating an arrangement method of a gate driver of a display device according to an example embodiment of the present disclosure;

FIG. 6 is a diagram illustrating a configuration of a gate driver included in a display device according to an example embodiment of the present disclosure;

FIG. 7 is diagram illustrating a light-emitting driving circuit included in a gate driver according to an example embodiment of the present disclosure;

FIG. 8 is a diagram illustrating a driving timing of the light-emitting driving circuit of FIG. 7;

FIG. 9 is a circuit diagram illustrating a gate driving circuit supplied with a driving voltage according to an example embodiment of the present disclosure;

FIGS. 10 and 11 are a circuit diagram and a waveform diagram illustrating a driving method and a driving waveform of a gate driving circuit in a second section;

FIG. 12 is a schematic plan view illustrating a layout structure of a display device;

FIG. 13 is a graph illustrating unstable signal output due to an increase in wire length;

FIG. 14 is a schematic plan view illustrating a layout structure of a display device according to an example embodiment of the present disclosure; and

FIG. 15 is a graph illustrating stable signal output resulting from adjustment of wire length according to an example embodiment of the present disclosure.

### DETAILED DESCRIPTION

The advantages and features of the present disclosure and methods for accomplishing the same will be more clearly understood from example embodiments described below with reference to the accompanying drawings. However, the present disclosure is not limited to the following embodiments but may be implemented in various different forms. Rather, the below example embodiments will make the disclosure of the present disclosure more complete and allow those skilled in the art to more completely comprehend the scope of the present disclosure.

The shapes, sizes, ratios, angles, numbers, and the like illustrated in the accompanying drawings for describing the embodiments of the present disclosure are merely examples, and the present disclosure is not limited thereto. Like reference numerals generally denote like elements throughout the present specification. Further, in describing the present disclosure, detailed descriptions of known related technologies may be omitted to avoid unnecessarily obscuring the subject matter of the present disclosure.

The terms such as “comprising,” “including,” “having,” and “consist of” used herein are generally intended to allow other components to be added unless the terms are used with a more liming term like “only.” Any references to singular may include plural, and vice versa, unless expressly stated otherwise.

Components are to be interpreted to include an ordinary error range even if not expressly stated.

Where a positional or interconnected relationship is described between two components with such terms as “on top of,” “above,” “below,” “next to,” “connect or couple with,” “crossing,” “intersecting,” or the like, one or more other components may be interposed between them, unless a more limiting term like “immediately” or “directly” is used.

Where a temporal antecedent relationship is described with such terms as “after,” “following,” “next to,” “before,” or the like, it may not necessarily be continuous on a time base unless a more limiting term like “immediately” or “directly” is used.

The terms “first,” “second,” and the like may be used to refer to elements separately from each other, but the functions or structures of the components are not limited by ordinal numbers or component names in front of the components.

The following embodiments can be partially or entirely bonded to or combined with each other and can be linked and operated in technically various ways. The embodiments can be carried out independently of or in association with each other.

Terms used in describing the below embodiments of the present disclosure (including technical and scientific terms) are to be construed as they would be commonly understood by one of ordinary skill in the art to which the present disclosure relates, unless otherwise specifically defined and described, and commonly used terms, such as dictionary defined terms, are to be construed in light of their contextual meaning in the relevant art.

In the display device according to the present disclosure, the pixel circuit and the gate driving circuit may include a plurality of transistors. The transistors may be implemented as oxide thin film transistors (oxide TFTs) including an oxide semiconductor, low temperature polysilicon (LTPS) TFTs including low temperature polysilicon, or the like.

A transistor is a three-electrode element including a gate, a source, and a drain. The source is an electrode that supplies carriers to the transistor. In the transistor, carriers start to flow from the source. The drain is an electrode through which carriers exit from the transistor. In a transistor, carriers flow from a source to a drain. In the case of an n-channel transistor, since carriers are electrons, a source voltage is a voltage lower than a drain voltage such that electrons may flow from a source to a drain. The n-channel transistor has a direction of a current flowing from the drain to the source. In the case of a p-channel transistor, since carriers are holes, a source voltage is higher than a drain voltage such that holes may flow from a source to a drain. In the p-channel transistor, since holes flow from the source to the drain, current flows from the source to the drain. It should be noted that a source and a drain of a transistor are not fixed. For example, a source and a drain may be changed according to an applied voltage. Therefore, the disclosure is not limited to a source and a drain of a transistor. In the following description, a source and a drain of a transistor will be referred to as a first electrode and a second electrode.

A gate signal may swing between a gate-on voltage and a gate-off voltage. The transistor is turned on in response to the gate-on voltage and is turned off in response to the gate-off voltage. In the case of the n-channel transistor, the gate-on voltage may be a gate high voltage (or a high driving voltage), the gate-off voltage may be a gate low voltage VGL (or a low driving voltage). In case of the p-channel transistor, the gate-on voltage may be a gate low voltage VGL, and the gate-off voltage may be a gate high voltage VGH.

Hereinafter, example embodiments of the present disclosure will be described in detail with reference to the accompanying drawings.

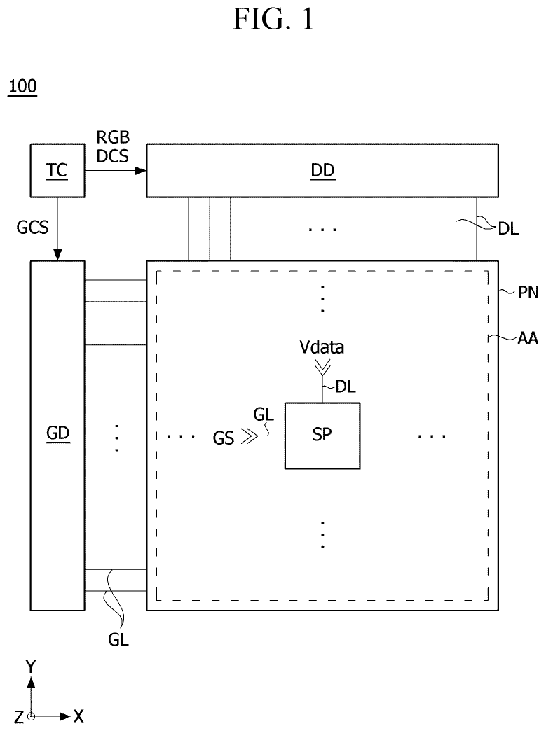

FIG. 1 is a schematic configuration diagram of a display device according to an example embodiment of the present disclosure.

As shown in FIG. 1, a display device 100 may include a display panel PN including a plurality of sub-pixels SP, a gate driver GD and a data driver DD, which supply various signals to the display panel PN, and a timing controller TC that controls the gate driver GD and the data driver DD.

The display panel PN includes a display area AA in which an input image is visually reproduced. The display area AA may include a plurality of pixels and a gate driving circuit. Each of the pixels disposed in the display area AA of the display panel PN may include sub-pixels of different colors. In the display area AA, a plurality of gate wires GL and a plurality of data wires DL are crossed with each other, and each of a plurality of sub-pixels SP may be connected to the gate wires GL and the data wires DL. In addition, each of the plurality of sub-pixels SP may also be connected to power wires, such as a high potential wire, a low potential wire, and a reference wire.

The plurality of sub-pixels SP is the smallest units constituting a screen, and each of the plurality of sub-pixels SP may include a light-emitting element and a sub-pixel circuit to drive the light-emitting element.

A plurality of light-emitting elements may be defined differently depending on the type of the display panel PN. For example, if the display panel PN is an inorganic light-emitting display panel, the light-emitting element may be a light-emitting diode (LED) or a micro light-emitting diode (micro LED).

The gate driver GD may supply a plurality of gate signals GS to a plurality of gate wires GL according to a plurality of gate control signals GCS provided from the timing controller TC. The number and arrangement of the gate driver GD are not limited to those shown. For example, the gate driver GD may be disposed as a plurality of blocks spaced apart on both sides including one side of the display panel PN, or may be disposed within the display area AA.

The data driver DD may convert the image data RGB input from the timing controller TC into a data voltage Vdata using a reference gamma voltage in accordance with a plurality of data control signals DCS provided from the timing controller TC. The data driver DD may supply the converted data voltage Vdata to the plurality of data wires DL. The data driver DD may be implemented as one or more source driver IC.

The timing controller TC may align the image data RGB input from the outside and supply the aligned image data to the data driver DD. The timing controller TC may generate a gate control signal GCS and a data control signal DCS using externally input synchronization signals, such as dot clock signals, data enable signals, and horizontal/vertical synchronization signals.

The timing controller TC may control the gate driver GD and the data driver DD by supplying the gate control signal GCS and the data control signal DCS to the gate driver GD and the data driver DD, respectively.

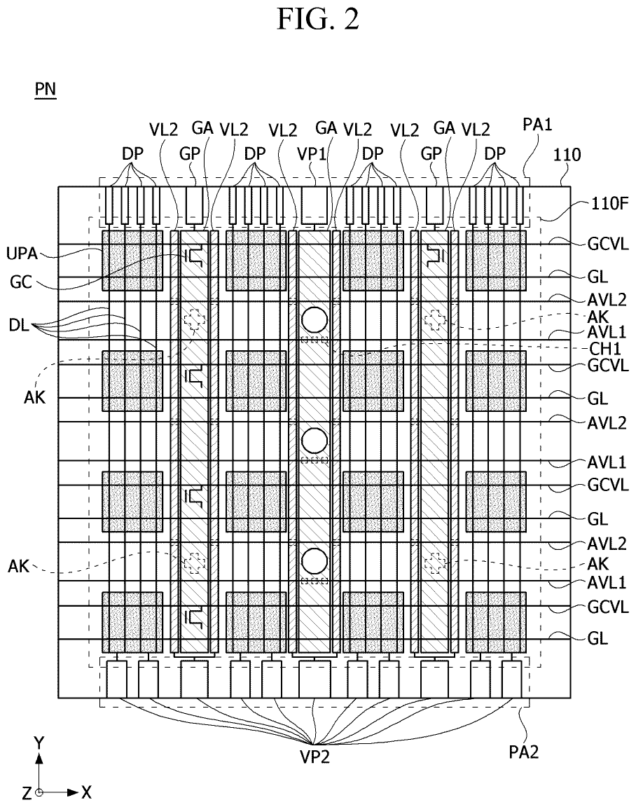

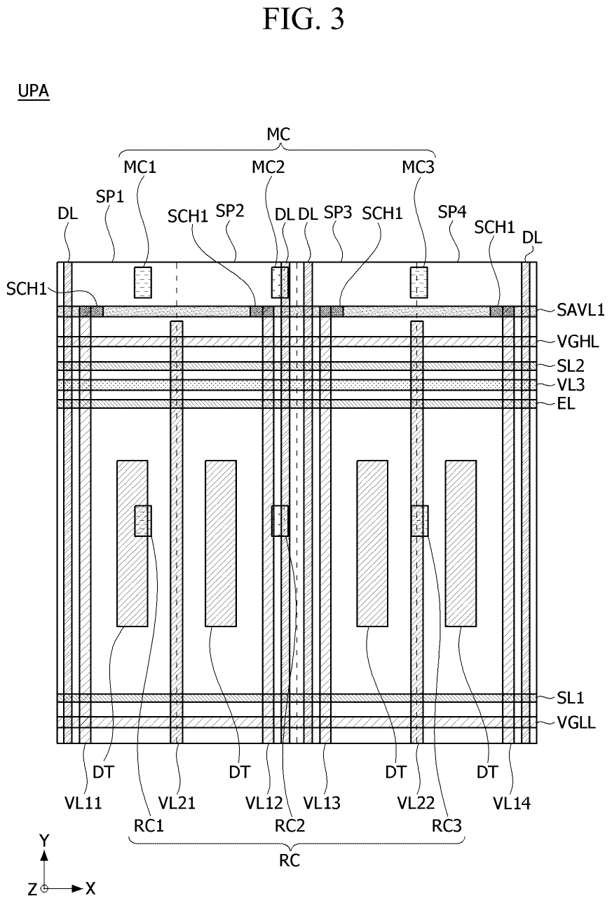

FIG. 2 is a schematic plan view of a display panel included in a display device according to an example embodiment of the present disclosure. FIG. 3 is a plan view of a unit pixel area included in a display device according to an example embodiment of the present disclosure.

As shown in FIGS. 2 and 3, the substrate 110 is configured to support the various components included in the display panel PN, and may be made of an insulating material. For example, the substrate 110 of the display panel PN may be made of glass or resin or the like. Additionally, the substrate 110 may be made of a polymer or plastic, or may be made of a material having flexibility.

The display area AA may include a plurality of unit pixel regions UPA. Each of the unit pixel regions UPA may include a pixel region in which sub-pixels SP1, SP2, SP3, and SP4 are provided, and a non-pixel region in which no sub-pixel is provided. Circuit elements of the gate driving circuit may be positioned in the non-pixel region. The unit pixel region UPA may include at least two sub-pixels SP. The unit pixel region UPA may include four sub-pixels SP1, SP2, SP3, and SP4, but the embodiments of the present disclosure are not limited thereto. The four sub-pixels may be a first sub-pixel SP1, a second sub-pixel SP2, a third sub-pixel SP3, and a fourth sub-pixel SP4.

Each of the plurality of sub-pixels may serve as an individual unit that emits light, and light emitting elements MC and RC and a sub-pixel circuit may be positioned in each of the plurality of sub-pixels. A sub-pixel unit including four sub-pixels SP1, SP2, SP3, and SP4 may include sub-pixels that emit light of at least two colors among a red sub-pixel, a green sub-pixel, and a blue sub-pixel, or may include sub-pixels that emit light of at least two colors among a red sub-pixel, a green sub-pixel, a blue sub-pixel, and a white sub-pixel, but the present disclosure is not limited thereto.

The sub-pixel unit may include at least two sub-pixels including a light emitting element having the lowest efficiency among a red light emitting element, a green light emitting element, and a blue light emitting element. In the case of an LED, the red light emitting element exhibits relatively low efficiency.

The sub-pixel circuit may include a driving transistor DT that provides a driving current to the light emitting elements MC and RC, and some of the plurality of light emitting elements MC and RC may be positioned to overlap the driving transistor DT.

The display device 100 according to one embodiment of the present disclosure may include the first and second sub-pixels SP1 and SP2 that emit red light, the third sub-pixel SP3 that emits green light, and the fourth sub-pixel SP4 that emits blue light, and the first sub-pixel SP1, the second sub-pixel SP2, the third sub-pixel SP3, and the fourth sub-pixel SP4 may be arranged side by side in a first direction (e.g., an X-axis direction).

As mentioned above, the display area is an area in which the plurality of sub-pixel units are positioned, and a non-display area is an area in which no sub-pixel unit is positioned and no image is displayed. In the non-display area, the gate driver GD for driving the plurality of sub-pixels SP arranged in the display area, wires, and pads for applying signals to the wires may be positioned. In one embodiment, at least a portion of the gate driver may be mounted in the display panel.

The gate driver GD may supply gate signals to the plurality of sub-pixels SP through the gate wire GL. The gate signals may include a scan signal and an emission signal.

The scan signal may be provided through a scan wire SL and the emission signal may be provided through an emission wire EL. Both the scan wire SL and the emission wire EL may be referred to as the gate wire GL.

Depending on the case, the scan wire SL may be a single wire or may include two or more wires. In the present disclosure, the scan wire SL may be described, by way of example, as including a first scan wire SL1 and a second scan wire SL2.

The gate driver GD may include a scan driver that provides the scan signal and a light emitting driver that provides the emission signal.

In the display device 100 according to one embodiment of the present disclosure, at least a portion of the gate driver GD may be divided into a plurality of parts on the substrate 110 and positioned in gate driving circuit regions GA located between the plurality of unit pixel regions UPA.

In the display device 100 according to one embodiment of the present disclosure, the light-emitting element may be an inorganic light-emitting diode (LED). Due to the high luminous efficiency of LEDs, the area occupied by the light-emitting elements MC, RC per unit pixel area UPA may be very small. A sub-pixel circuit may be disposed in each sub-pixel SP1, SP2, SP3, SP4, and at least one light-emitting element MC, RC associated with the sub-pixel circuit may be disposed. And, a gate driving circuit GC may be disposed in the non-pixel area between at least neighboring unit pixel areas UPA.

The light emitting elements MC and RC may be positioned on the substrate 110 through a transfer process, and in this case, an alignment key AK for aligning the light emitting elements MC and RC with the substrate 110 may be provided in the gate driving circuit region GA. The alignment key AK may be positioned between the gate driving circuits GC arranged in a second direction (e.g., a Y-axis direction) in the gate driving circuit region GA.

The gate driving circuit region GA may be positioned in the second direction (e.g., the Y-axis direction) between adjacent unit pixel regions UPA, and the gate driving circuit GC may be positioned in the gate driving circuit region GA. The gate driving circuit GC may be electrically connected to the plurality of gate driving circuits GC arranged in the first direction (e.g., the X-axis direction) to provide the gate signals to the sub-pixels arranged in the same row. In this case, a gate driving wire GCVL for transmitting a signal to enable the gate driving circuit GC to operate may be positioned in the first direction (e.g., the X-axis direction). The gate driving wire GCVL may include a high voltage wire VGHL and a low voltage wire VGLL. The high voltage wire VGHL and the low voltage wire VGLL may be positioned in the first direction (e.g., the X-axis direction) in the unit pixel region UPA.

As described above, since the gate driver includes the scan driver and the light emitting driver, the gate driving circuit GC may include a scan driving circuit and a light emitting driving circuit. The gate driving circuit may also be referred to as the scan driving circuit or the light emitting driving circuit. The gate driving wire may be referred to as a scan driving wire or a light emitting driving wire. The scan driving circuit and the light emitting driving circuit may be positioned in the same row but in different regions.

The data driver DD may convert image data into a data signal and supply the converted data signal to the sub-pixels SP1, SP2, SP3, and SP4 through the data wire DL. The data driver DD may be formed on the rear surface of the substrate 110 or may be formed on a separate substrate. When the data driver DD is formed on one surface of the separate substrate, the other surface of the separate substrate on which the data driver DD is not formed may be bonded to the rear surface of the substrate 110 such that they face each other.

To electrically connect the front surface and the rear surface of the substrate 110 or to electrically connect the front surface of the substrate 110 and the other surface of the separate substrate, a side wire may be provided on the side surface of the substrate 110 or on the side surfaces of both the substrate 110 and the separate substrate. Accordingly, the data driver positioned on the rear surface of the substrate 110 or the other surface of the separate substrate may supply the data signal to the sub-pixel SP through the side wire.

As described above, in the display device 100 according to one embodiment of the present disclosure, the gate driver GD may be positioned between adjacent sub-pixel units on the substrate 110. However, the present disclosure is not limited thereto, and the gate driver GD may be positioned at one side or both sides of the substrate 110.

The gate wire GL may be positioned in the first direction (e.g., the X-axis direction) on the substrate 110, and the data wire DL may be positioned in the second direction (e.g., the Y-axis direction). The gate wire GL and the data wire DL may be provided in all of the sub-pixels SP, and may supply signals to the sub-pixel circuits provided in the sub-pixels SP.

Pad regions PA1 and PA2 in which pads are provided may be formed at opposite sides of the substrate 110, i.e., at the upper portion and the lower portion of the substrate 110 in the second direction (e.g., the Y-axis direction). In this case, a pad region formed at the upper portion of the substrate 110 may be referred to as a first pad region PA1, and a pad region formed at the lower portion of the substrate 110 may be referred to as a second pad region PA2. In the substrate 110, the first pad region PA1 and the second pad region PA2 may be opposite each other.

In the first pad region PA1, a data pad DP connected to the data wire DL, a gate pad GP connected to the gate driver GD, a high-potential voltage pad VP1 connected to a high-potential voltage wire, and a reference voltage pad connected to a reference voltage wire VL3 may be arranged. In this case, the data pads DP may be provided in a number corresponding to the number of the sub-pixels SP included in the sub-pixel unit. A data signal corresponding to pixel data is applied to the data pad DP. The high-potential voltage wire may be referred to as a first power wire, and the reference voltage wire VL3 may be referred to as a second power wire.

In the gate driver GD, a wire for providing various clock signals, a wire for providing a gate low voltage, and a wire for providing a gate high voltage may be positioned to transmit signals. The gate drivers GD may be arranged side by side in the second direction (e.g., the Y-axis direction), so that the wires for transmitting signals to the gate drivers GD may be aligned with the gate drivers GD. The wires for transmitting signals to the gate driver GD are referred to as the gate driving wires, and the gate driving wire may be positioned in the second direction (e.g., the Y-axis direction), and may be connected to the gate pad GP provided in the first pad region PA1 to receive a signal from the gate pad GP.

The high-potential voltage wire may be positioned in the second direction (e.g., the Y-axis direction) between adjacent unit pixel regions UPA. The high-potential voltage wire positioned in the second direction (e.g., the Y-axis direction) may provide a high-potential voltage to the plurality of sub-pixels SP through the high-potential voltage pad VP1 located in the first pad region PA1. The plurality of high-potential voltage wires VL1 positioned in the second direction (e.g., the Y-axis direction) may be connected to an auxiliary high-potential voltage wire AVL1 positioned in the first direction (e.g., the X-axis direction) to form a mesh structure. The auxiliary high-potential voltage wire AVL1 may be positioned between adjacent unit pixel regions UPA in every row in which the sub-pixels are arranged, or in every multiple rows. The auxiliary high-potential voltage wire AVL1 may prevent a voltage drop on the high-potential voltage wire and may provide a high-potential voltage to the plurality of sub-pixels SP.

High-potential voltage wires VL11, VL12, VL13, and VL14 may be positioned in the second direction (e.g., the Y-axis direction) for the respective sub-pixels SP1, SP2, SP3, and SP4 arranged in the unit pixel region UPA. The plurality of high-potential voltage wires VL11, VL12, VL13, and VL14 positioned in the unit pixel region UPA may be connected to an auxiliary high-potential voltage wire SAVL1 positioned in the first direction (e.g., X-axis direction) in the unit pixel region UPA through contact holes SCHI to form a mesh structure.

The high-potential voltage wires VL1, VL11, VL12, VL13, and VL14 and the auxiliary high-potential voltage wires AVL1 and SAVL1, which are positioned inside and outside the unit pixel region UPA, may be electrically connected to each other to form a mesh structure, and may receive a high-potential voltage through the high-potential voltage pad VP1.

A low-potential voltage pad VP2 connected to low-potential voltage wires VL2, VL21, and VL22 may be provided in the second pad region PA2. The low-potential voltage wires VL2, VL21, and VL22 may be positioned on both sides of the gate driving circuit region GA and between adjacent sub-pixels, and may provide a low-potential voltage to the sub-pixels. However, the present disclosure is not limited thereto, and the low-potential voltage wire may be positioned in each of the sub-pixels. The low-potential voltage wires VL2, VL21, and VL22 may be referred to as the second power wires.

The plurality of low-potential voltage wires VL21 and VL22 positioned in the second direction (e.g., the Y-axis direction) may be connected to an auxiliary low-potential voltage wire AVL2 positioned in the first direction (e.g., the X-axis direction). The auxiliary low-potential voltage wire AVL2 may be positioned in every row in which the unit pixel regions UPA are arranged, or in every multiple rows. The auxiliary low-potential voltage wire AVL2 may prevent a voltage drop on the low-potential voltage wires VL21 and VL22, and may provide a low-potential voltage to the plurality of sub-pixels.

The reference voltage wire VL3 may be positioned in the first direction (e.g., the X-axis direction) for each of the unit pixel regions UPA arranged in the first direction (e.g., the X-axis direction). The reference voltage wire VL3 positioned in the first direction (e.g., the X-axis direction) may provide a reference voltage to the sub-pixel unit through a wire separately positioned in the second direction (e.g., the Y-axis direction). The reference voltage wire VL3 may be connected to the reference voltage pad located in the first pad region PA1, and the reference voltage may be provided to the plurality of reference voltage wires VL3 through the reference voltage pad.

In the display panel PN included in the display device 100 according to one embodiment of the present disclosure, the edge of the substrate 110 may be removed by grinding to reduce a bezel.

The bezel refers to the edge region of the substrate 110 in which the sub-pixels SP1, SP2, SP3, and SP4 are not provided. During the grinding process, portions of pads and wires positioned at the edge of the substrate 110 may be removed, and the size of the substrate 110 may be reduced, so that the display panel PN may be implemented with the size of a final substrate 110F.

Specifically, in the final substrate 110F, most of the pads arranged in the first pad region PA1 and the second pad region PA2 may be removed, and only a portion or traces of the pads may remain.

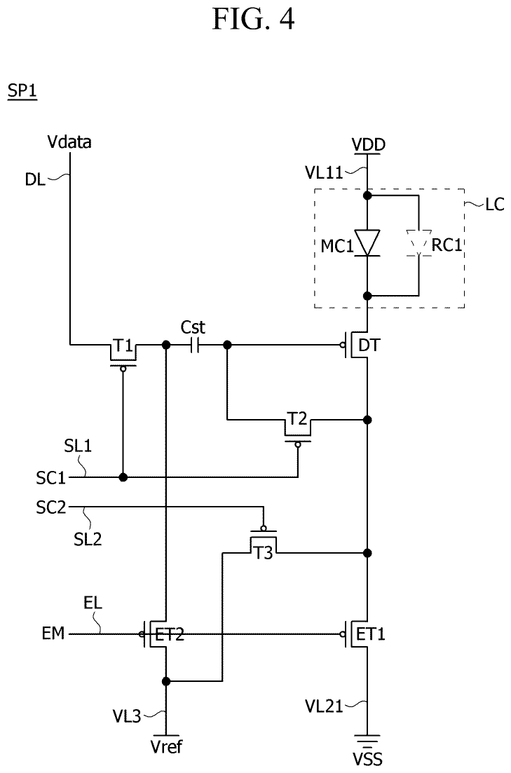

FIG. 4 is a circuit diagram of a sub-pixel included in a display device according to an example embodiment of the present disclosure. Although the illustrated circuit diagram is assumed to be the sub-pixel circuit included in the first sub-pixel SP1, this may also be applied to the sub-pixel circuits included in the other sub-pixels SP2, SP3, and SP4.

As shown in FIG. 4, the first sub-pixel SP1 may include a light emitting element LC and the sub-pixel circuit configured to provide a driving current to the light emitting element LC.

The light emitting element LC may include a first main light emitting element MC1 and a first auxiliary light emitting element RC1, but is not limited thereto. For example, assuming that the sub-pixel circuit included in the first sub-pixel SP1 is referred to as a first sub-pixel circuit, the sub-pixel circuit included in the second sub-pixel SP2 is referred to as a second sub-pixel circuit, the sub-pixel circuit included in the third sub-pixel SP3 is referred to as a third sub-pixel circuit, and the sub-pixel circuit included in the fourth sub-pixel SP4 is referred to as a fourth sub-pixel circuit, the first sub-pixel circuit may be connected to the first main light emitting element MC1, the second sub-pixel circuit may be connected to the first auxiliary light emitting element RC1, the third sub-pixel circuit may be connected to a second main light emitting element MC2 and a second auxiliary light emitting element RC2, and the fourth sub-pixel circuit may be connected to a third main light emitting element MC3 and a third auxiliary light emitting element RC3. Among these, when two light emitting elements are connected to one sub-pixel circuit, the two light emitting elements may be connected in parallel with each other.

The first main light emitting element MC1 and the first auxiliary light emitting element RC1 may be arranged in parallel, but are not limited thereto.

The anode electrode of the first main light emitting element MC1 and the anode electrode of the first auxiliary light emitting element RC1 may be connected to the high-potential voltage wire VL11 to which a high-potential voltage VDD is supplied. The cathode electrode of the first main light emitting element MC1 and the cathode electrode of the first auxiliary light emitting element RC1 may be connected to the sub-pixel circuit.

The sub-pixel circuit may include six transistors and one capacitor.

The transistor may be a thin-film transistor, and may be either an n-channel or a p-channel transistor. In the present disclosure, the transistor will be described as a p-channel transistor. However, the embodiments of the present disclosure are not limited thereto. In addition, the transistor may be formed of a semiconductor material such as an oxide semiconductor, amorphous silicon, or polysilicon, but is not limited thereto.

The driving transistor DT may include a gate electrode, a source electrode, and a drain electrode, wherein the gate electrode may be connected to one electrode of a capacitor Cst, the source electrode may be connected to the cathode electrodes of the first main light emitting element MC1 and the first auxiliary light emitting element RC1, and the drain electrode may be connected to the source electrode of a first light emitting transistor ET1. The driving transistor DT may be controlled by a voltage applied to the gate electrode to control the voltage at the cathode electrodes of the first main light emitting element MC1 and the first auxiliary light emitting element RC1. Accordingly, the first main light emitting element MC1 and the first auxiliary light emitting element RC1 may emit light.

A first transistor T1 may include a gate electrode, a source electrode, and a drain electrode, wherein the gate electrode may be connected to the first scan wire SL1, the source electrode may be connected to the data wire DL, and the drain electrode may be connected to the other electrode of the capacitor Cst. The first transistor T1 may be controlled by a first scan signal SC1 to provide the data voltage Vdata to the other electrode of the capacitor Cst.

A second transistor T2 may include a gate electrode, a source electrode, and a drain electrode, wherein the gate electrode may be connected to the first scan wire SL1, the source electrode may be connected to one electrode of the capacitor Cst, and the drain electrode may be connected to the drain electrode of the driving transistor DT. The second transistor T2 may be controlled by the first scan signal SC1 to electrically connect the gate electrode of the driving transistor DT to the drain electrode of the driving transistor DT, thereby forming a diode connection. Accordingly, the second transistor T2 may sample the threshold voltage of the driving transistor DT.

A third transistor T3 may include a gate electrode, a source electrode, and a drain electrode, wherein the gate electrode may be connected to the second scan wire SL2, the source electrode may be connected to the drain electrode of the driving transistor DT, and the drain electrode may be connected to the reference voltage wire VL3. The third transistor T3 may be controlled by a second scan signal SC2 to provide a reference voltage Vref to the drain electrode of the driving transistor DT.

The first light emitting transistor ET1 may include a gate electrode, a source electrode, and a drain electrode, wherein the gate electrode may be connected to the emission wire EL, the source electrode may be connected to the drain electrode of the driving transistor DT, and the drain electrode may be connected to the low-potential voltage wire VL21. The first light emitting transistor ET1 may be controlled by an emission signal EM to provide a low-potential voltage VSS to the drain electrode of the driving transistor DT.

A second light emitting transistor ET2 may include a gate electrode, a source electrode, and a drain electrode, wherein the gate electrode may be connected to the emission wire EL, the source electrode may be connected to the other electrode of the capacitor Cst and the drain electrode of the first transistor T1, and the drain electrode may be connected to the reference voltage wire VL3. The second light emitting transistor ET2 may be controlled by the emission signal EM to provide the reference voltage Vref to the other electrode of the capacitor Cst and the drain electrode of the first transistor T1.

The source electrodes and/or drain electrodes of the transistors described above may be referred to differently depending on the type of the transistor or the voltage applied thereto.

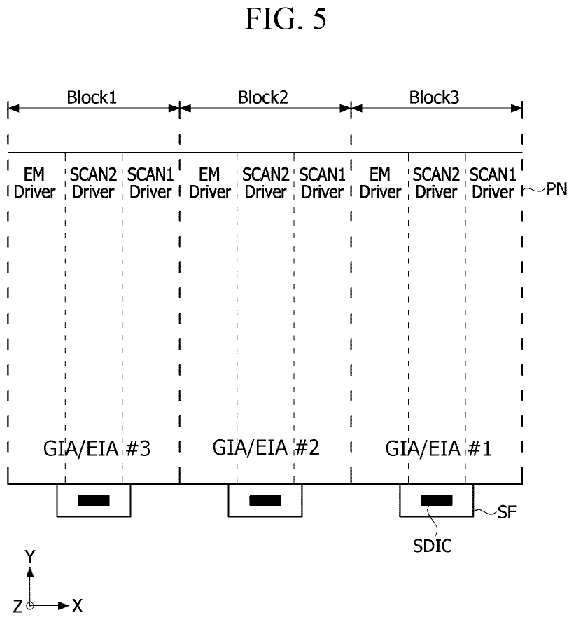

FIG. 5 is a diagram illustrating an arrangement method of a gate driver in a display device according to an example embodiment of the present disclosure. FIG. 5 illustrates a configuration of a gate driver that supplies a driving signal to the sub-pixel circuit shown in FIG. 4.

The sub-pixel circuit may be driven by receiving the first scan signal SC1, the second scan signal SL2, and the emission signal EM. The gate driver may include a first scan driver (SCAN1 Driver) that sequentially outputs the first scan signal SC1, a second scan driver (SCAN2 Driver) that sequentially outputs the second scan signal SC2, and an emission driver (EM Driver) that sequentially outputs the emission signal EM.

As shown in FIG. 5, the entire region of the display panel PN may be divided into three blocks Block1, Block2, and Block3 and may be driven accordingly. Here, the blocks Block1, Block2, and Block3 may include gate drivers GIA/EIA #1, GIA/EIA #2, and GIA/EIA #3, each including the first scan driver (SCAN1 Driver), the second scan driver (SCAN2 Driver), and the emission driver (EM Driver). The gate drivers GIA/EIA #1, GIA/EIA #2, and GIA/EIA #3 may be positioned in the pixel region.

In the display device 100 according to one embodiment of the present disclosure, the gate driver GD may be implemented in a gate driver in array (GIA) scheme in which scan drivers are positioned between pixel regions, and in an emission driver in array (EIA) scheme in which light emitting drivers are positioned between pixel regions.

The sub-pixels of each of the blocks Block1, Block2, and Block3 may be electrically connected to a source driver IC SDIC that supplies a data signal to each sub-pixel. The number and arrangement method of the gate drivers GIA/EIA #1, GIA/EIA #2, and GIA/EIA #3 and the source driver ICs SDIC provided in the display panel PN are merely one embodiment, and the number and arrangement method may be variously modified and applied. The source driver IC SDIC may be mounted on a flexible film SF, e.g., a chip on film (COF). The COF SF on which the source driver IC SDIC is mounted may be bonded to a pad region located in the display panel PN using an anisotropic conductive film (ACF), and may be electrically connected to pads of the pad region.

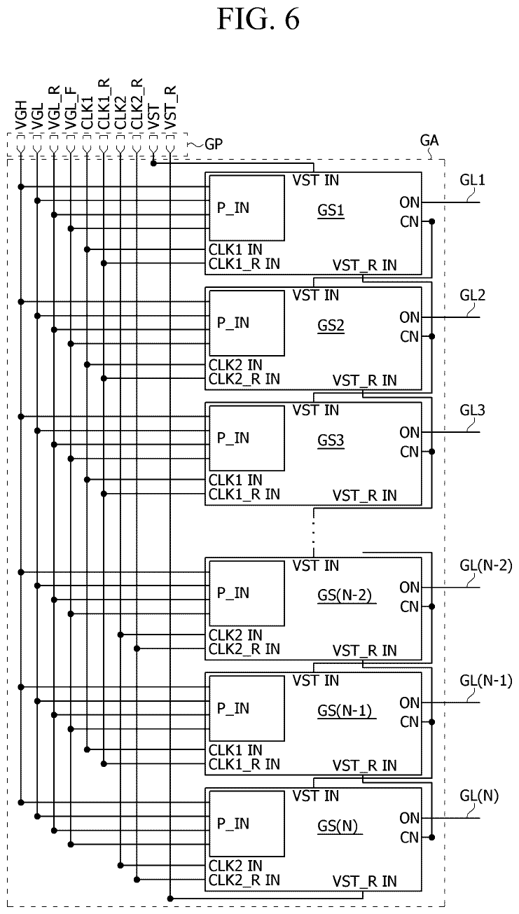

FIG. 6 is a diagram illustrating a configuration of a gate driver included in a display device according to an example embodiment of the present disclosure. The gate driver shown in FIG. 6 represents a light-emitting driver.

As shown in FIG. 6, the gate driver may include a plurality of stages GS1, GS2, GS3, . . . , GS(N−2), GS(N−1), and GS(N). The number of the plurality of stages is N, where N is a natural number.

A plurality of clock signal wires, a plurality of voltage wires, and a plurality of signal wires for driving the plurality of stages GS1, GS2, GS3, . . . , GS(N−2), GS(N−1), and GS(N) may be arranged in the gate driving circuit region GA.

The plurality of clock signal wires may include a first clock signal wire for providing a first clock signal CLK1, a first reverse clock signal wire for providing a first reverse clock signal CLK1_R, a second clock signal wire for providing a second clock signal CLK2, and a second reverse clock signal wire for providing a second reverse clock signal CLK2_R.

The plurality of voltage wires may include a high voltage wire for providing the gate high voltage VGH, a low driving voltage wire for providing the low driving voltage VGL, a forward low driving voltage wire for providing a forward low driving voltage VGL_F, and a reverse low driving voltage wire for providing a reverse low driving voltage VGL_R.

The plurality of signal wires may include a start signal wire for providing a start signal VST, a reverse start signal wire for providing a reverse start signal VST_R, and a reset signal wire for providing a reset signal.

The plurality of stages GS1, GS2, GS3, . . . , GS(N−2), GS(N−1), and GS(N), the plurality of clock signal wires, and the plurality of voltage wires may be arranged in the gate driving circuit region GA, and the gate pads GP that provide signals may be positioned at the ends of the plurality of clock signal wires and the plurality of voltage wires.

Each of the plurality of stages GS1, GS2, GS3, . . . , GS(N−2), GS(N−1), and GS(N) may include a low power input node P_IN and clock signal input node CLK IN. The power input P_IN may include a plurality of nodes and may receive voltages supplied from the plurality of voltage wires.

For example, when N is an even number, the odd-numbered stages GS1, GS3, . . . , GS(N−1) among the plurality of stages GS1, GS2, GS3, . . . , GS(N−2), GS(N−1), and GS(N) may be connected to the first clock signal wire for providing the first clock signal CLK1 and the first reverse clock signal wire for providing the first reverse clock signal CLK1_R.

In one embodiment, the odd-numbered stages GS1, GS3, . . . , GS(N−1) may also be connected to the second clock signal wire for providing the second clock signal CLK2 and the second reverse clock signal wire for providing the second reverse clock signal CLK2_R.

The even-numbered stages GS2, . . . , GS(N−2), and GS(N) may be connected to the second clock signal wire for providing the second clock signal CLK2 and the second reverse clock signal wire for providing the second reverse clock signal CLK2_R.

In one embodiment, the even-numbered stages GS2, . . . , GS(N−2), and GS(N) may also be connected to the first clock signal wire for providing the first clock signal CLK1 and the first reverse clock signal wire for providing the first reverse clock signal CLK1_R.

Each of the plurality of stages GS1, GS2, GS3, . . . , GS(N−2), GS(N−1), and GS(N) may include a start signal node VST IN that receives the start signal VST, and a reverse start signal node VST_R IN that receives the reverse start signal VST_R. In this case, the start signal node VST IN of a first stage GS1 may be connected to the start signal wire for providing the start signal VST, and the reverse start signal node VST_R IN of an N^{th} stage GS(N) may be connected to the reverse start signal wire for providing the reverse start signal VST_R.

The start signal node VST IN of each of a second stage GS2 to an (N−1)^{th} stage GS(N−1) may be connected to a carry node CN of its preceding stage to receive a carry signal. The reverse start signal node VST_R IN of each of the second stage GS2 to the (N−1)^{th} stage GS(N−1) may be connected to the carry node CN of its subsequent stage to receive a carry signal.

An output node ON included in each of the plurality of stages GS1, GS2, GS3, . . . , GS(N−2), GS(N−1), and GS(N) may be connected to the gate wire and may output a gate signal. The first stage GS1 may be connected to a first gate wire GL1, the second stage GS2 may be connected to a second gate wire GL2, the third stage GS3 may be connected to a third gate wire GL3, the (N−2)^{th} stage GS(N−2) may be connected to an (N−2)^{th} gate wire GL (N−2), an (N−1)^{th} stage GS(N−1) may be connected to an (N−1)^{th} gate wire GL (N−1), and the N^{th} stage GS(N) may be connected to an N^{th} gate wire GL (N). In this case, the gate wire may be the emission wire.

The gate driver according to one embodiment of the present disclosure may be sequentially driven from the first stage GS1 to the N^{th} stage GS(N) by the start signal VST to output gate signals, and may be sequentially driven in a reverse direction from the N^{th} stage GS(N) to the first stage GS1 by the reverse start signal VST_R to output gate signals. Accordingly, the gate driver according to one embodiment of the present disclosure may enable bidirectional driving by using a single gate driver, thereby reducing cost.

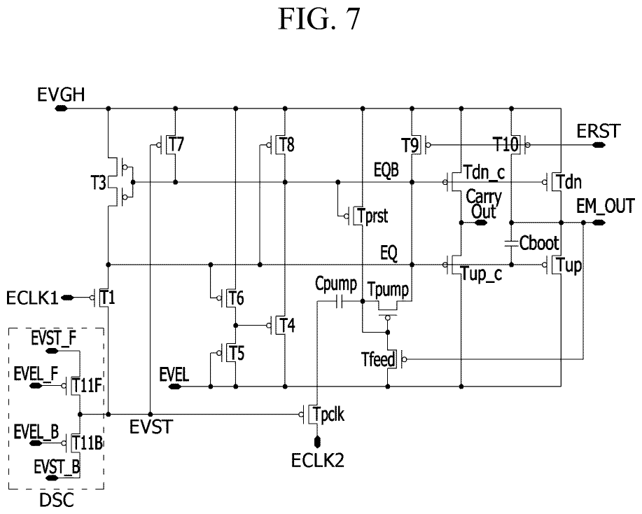

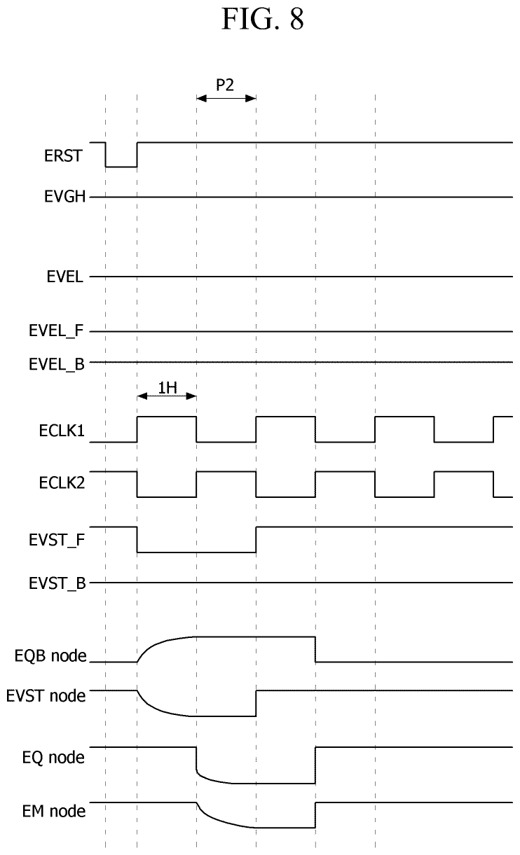

FIG. 7 is a diagram illustrating a light emitting driving circuit included in a gate driver according to an example embodiment of the present disclosure. FIG. 8 is a diagram illustrating a driving timing of the light emitting driving circuit shown in FIG. 7.

One light emitting driving circuit may be distributed across the plurality of gate driving circuit regions GA. Specifically, the light emitting driving circuit may be distributed across the plurality of gate driving circuit regions GA located in a row in which the emission wire EL, to which the emission signal EM is applied, is positioned. In addition, one light emitting driving circuit may be included in any one of the plurality of stages GS1, GS2, GS3, . . . , GS(N−2), GS(N−1), and GS(N) shown in FIG. 6.

Transistors included in the light emitting driving circuit may be thin film transistors each having a gate electrode, a first source/drain electrode, and a second source/drain electrode, and may be p-channel transistors, but the embodiments of the present disclosure are not limited thereto. The p-channel transistor may be turned on when the low driving voltage is applied to the gate electrode, and may be turned off when the high voltage is applied to the gate electrode.

As shown in FIGS. 7 and 8, the light emitting driving circuit serving as the gate driving circuit included in the odd-numbered stage GS (2K-1) may be driven by a high driving voltage EVGH, a low driving voltage EVEL, a forward low voltage EVEL_F, a reverse low voltage EVEL_B, a forward start signal EVST_F, a reverse start signal EVST_B, the first and second clock signals ECLK1 and ECLK2, and an emission control reset signal ERST, and may output a carry signal Carry Out and an emission signal EM_OUT. The high driving voltage EVGH, the low driving voltage EVEL, the forward low voltage EVEL_F, and the reverse low voltage EVEL_B may be constant voltages (or DC voltages) outputted from a power IC.

The light-emitting driving circuit may include a pull-up transistor Tup, a pull-down transistor Tdn, a plurality of transistors T1, T3, T4, T5, T6, T7, T8, T9, T10, Tup_c, Tdn_c, Tpump, Tfeed, Tpclk, and Tprst and at least one capacitor Cpump or Cboot for generating an emission signal, and a direction selection circuit DSC for selecting forward driving or reverse driving.

The pull-up transistor Tup may be electrically connected between an input terminal of the low driving voltage EVEL and an output terminal of the emission signal EM_OUT. The gate electrode of the pull-up transistor Tup is connected to a Q node EQ. The pull-up transistor Tup may be controlled by a voltage level of the Q node EQ. The low driving voltage EVEL may be, for example, a low potential driving voltage. The pull-up transistor Tup may control the output of the emission signal EM at a turn-on level to the gate wire GL. The low driving voltage EVEL input terminal may be interpreted as a first driving voltage wire.

The pull-down transistor Tdn may be electrically connected between a high driving voltage EVGH input terminal and the output terminal of the emission signal EM. The pull-down transistor Tdn may be controlled by a voltage level of a QB node EQB. The high driving voltage EVGH may be, for example, a high potential driving voltage. The pull-down transistor Tdn may control an output of the emission signal EM at a turn-off level to the gate wire GL. The high driving voltage EVGH input terminal may be interpreted as a second driving voltage wire.

A first transistor T1 may be electrically connected between a start signal input node EVST and the Q node EQ. The gate electrode of the first transistor T1 may be connected to a first clock signal ECLK1 input terminal. The first transistor T1 may operate in response to a voltage level of the first clock signal ECLK1. The first transistor T1 may be turned on when the first clock signal ECLK1 is at a low level, which is a turn-on level, to connect the start signal input node EVST to the Q node EQ.

A third transistor T3 may be electrically connected between the high driving voltage EVGH input terminal and the Q node EQ. The third transistor T3 may operate in response to a voltage level of the QB node EQB.

A fourth transistor T4 may be electrically connected between the low driving voltage EVEL input terminal and the QB node EQB. The fourth transistor T4 may operate in response to a voltage level of a node between a fifth transistor T5 and a sixth transistor T6. The fourth transistor T4 includes a first electrode connected to the QB node EQB, a gate electrode connected to the first electrode of the fifth transistor T5 and the second electrode of the sixth transistor T6, and a second electrode connected to the low driving voltage EVEL input terminal.

The fifth transistor T5 and the sixth transistor T6 may be electrically connected between the low driving voltage EVEL input terminal and the high driving voltage EVGH input terminal. The fifth transistor T5 may operate in response to a voltage level of the low driving voltage EVEL. The sixth transistor T6 may operate in response to a voltage level of the Q node EQ. The fifth transistor T5 includes a first electrode connected to the gate electrode of the fourth transistor T4 and the second electrode of the sixth transistor T6, and a gate electrode and a second electrode connected to the low driving voltage EVEL input terminal. The sixth transistor T6 includes a first electrode connected to an input terminal of the high driving voltage EVGH input terminal, a gate electrode connected to the Q node EQ, and a second electrode connected to the gate electrode of the fourth transistor T4 and the first electrode of the fifth transistor T5.

By the operations of the fourth, fifth, and sixth transistors T4, T5, and T6, when the Q node EQ is at a low voltage, a high voltage may be maintained at the QB node EQB, and when the Q node EQ is at a high voltage, a low voltage may be applied to the QB node EQB. When the Q node EQ is at a low voltage, the sixth transistor T6 may be turned on to apply the high driving voltage EVGH to the gate electrode of the fourth transistor T4, thereby turning off the fourth transistor T4 and maintaining the high driving voltage EVGH at the QB node EQB. When the Q node EQ is at a high voltage, the sixth transistor T6 may be turned off, and the fourth transistor T4 may be turned on by the fifth transistor T5 that is turned on. The turned-on fourth transistor T4 may provide the low driving voltage EVEL to the QB node EQB.

A seventh transistor T7 and an eighth transistor T8 may be electrically connected between the high driving voltage EVGH input terminal and the QB node EQB. The seventh transistor T7 may operate in response to a signal supplied to the start signal input node EVST. The eighth transistor T8 may operate in response to a voltage level of the Q node EQ. When the Q node EQ is at a low voltage, the eighth transistor T8 may set and maintain the QB node EQB at the high voltage EVGH.

A ninth transistor T9 may be electrically connected between the high driving voltage EVGH input terminal and the Q node EQ. The tenth transistor T10 may be electrically connected between the high driving voltage EVGH input terminal and the output terminal of the emission signal EM. The ninth transistor T9 and the tenth transistor T10 may operate in response to an emission control reset signal ERST.

A pull-up transistor Tup_c and a pull-down transistor Tdn_c for the output of a carry signal Carry may be provided separately from the pull-up transistor Tup and the pull-down transistor Tdn for the output of the emission signal EM. The pull-up transistor Tup_c and the pull-down transistor Tdn_c for the output of the carry signal may operate simultaneously with the pull-up transistor Tup or the pull-down transistor Tdn for the output of the emission signal EM to output the carry signal Carry.

A boot capacitor Cboot may be electrically connected between the Q node EQ and the output terminal of the emission signal EM. The Q node EQ may be coupled to the output terminal of the emission signal EM by the boot capacitor Cboot. At a time point when a turn-on level of the emission signal EM is outputted as a voltage level at the output terminal of the emission signal EM is lowered, a voltage level at the Q node EQ may be lowered by the boot capacitor Cboot.

A pump capacitor Cpump is connected between a pump transistor Tpump and a clock transistor Tpclk. The pump capacitor Cpump may be connected to the Q node EQ when the pump transistor Tpump is turned on, and may be electrically connected to a second clock signal ECLK2 input terminal when the clock transistor Tpclk is turned on. The pump capacitor Cpump may maintain a voltage level of the Q node EQ at a sufficiently low voltage level during a period in which a turn-on level of the emission signal EM is maintained.

The pump transistor Tpump may be electrically connected between the pump capacitor Cpump and the Q node EQ. When the pump transistor Tpump is turned on, the pump capacitor Cpump may be electrically connected to the Q node EQ. The pump transistor Tpump includes a gate electrode and a first electrode connected to a reset transistor Tprst and the pump capacitor Cpump, and a second electrode connected to the Q node EQ. The pump transistor Tpump may operate in response to a signal supplied through a feed transistor Tfeed.

The feed transistor Tfeed may be electrically connected between the gate electrode of the pump transistor Tpump and the low driving voltage EVEL input terminal. The feed transistor Tfeed may operate in response to a voltage level of the emission signal EM. The feed transistor Tfeed includes a first electrode connected to the gate electrode and the first electrode of the pump transistor Tpump, a gate electrode connected to the output terminal of the emission signal EM_OUT, and a second electrode connected to the low driving voltage EVEL input terminal. The low driving voltage EVEL may be a first driving voltage.

The clock transistor Tpclk may be electrically connected between the pump capacitor Cpump and the second clock signal ECLK2 input terminal. The clock transistor Tpclk may operate in response to a voltage level of the start signal input node EVST to which the forward or reverse start signal EVST_F or EVST_B is inputted.

The reset transistor Tprst may be electrically connected between the high driving voltage EVGH input terminal and the pump capacitor Cpump. The reset transistor Tprst may be electrically connected to the gate node of the pump transistor Tpump. The reset transistor Tprst may operate in response to a voltage level of the QB node EQB.

When the emission control reset signal ERST at a turn-on level is supplied, the ninth transistor T9 and the tenth transistor T10 may be turned on, and the high driving voltage EVGH may be supplied to the Q node EQ and to the output terminal of the emission signal EM. The Q node EQ may be maintained at a high level, the QB node EQB may be maintained at a low level, and the emission signal EM at a turn-off level may be outputted.

The direction selection circuit DSC may apply either the forward start signal EVST_F for forward operation of the light emitting driving circuit or the reverse start signal EVST_B for reverse operation of the light emitting driving circuit to the start signal input node EVST.

The direction selection circuit DSC may include a forward selection transistor T11F and a reverse selection transistor T11B.

The forward selection transistor T11F is a transistor for forward operation. The gate electrode of the forward selection transistor T11F may be connected to the forward low voltage EVEL_F, the first source/drain electrode thereof may be connected to a forward start signal EVST_F wire, and the second source/drain electrode thereof may be connected to the start signal input node EVST. Accordingly, when the forward low voltage EVEL_F is inputted, the forward selection transistor T11F may apply the forward start signal EVST_F to the start signal input node EVST.

The reverse selection transistor T11B is a transistor for reverse operation. The gate electrode of the reverse selection transistor T11B may be connected to the reverse low voltage EVEL_B, the first source/drain electrode thereof may be connected to a reverse start signal EVST_B wire, and the second source/drain electrode thereof may be connected to the start signal input node EVST. Accordingly, when the reverse low voltage EVEL_B is inputted, the reverse selection transistor T11B may apply the reverse start signal EVST_B to the start signal input node EVST.

As shown in the waveform diagram of FIG. 8, during forward operation, the forward low voltage EVEL_F may be maintained at a low level, and the reverse low voltage EVEL_B may be maintained at a high level. Accordingly, while the forward operation is being performed, the forward selection transistor T11F may remain in a continuously turned-on state, and the reverse selection transistor T11B may remain in a turned-off state. Conversely, during reverse operation, the forward low voltage EVEL_F may be maintained at a high level, and the reverse low voltage EVEL_B may be maintained at a low level. Accordingly, while the reverse operation is being performed, the forward selection transistor T11F may remain in a continuously turned-off state, and the reverse selection transistor T11B may remain in a turned-on state.

During the forward operation of the light emitting driving circuit, the forward selection transistor T11F may be turned on by the forward low voltage EVEL_F to apply the forward start signal EVST_F to the start signal input node EVST. The forward selection transistor T11F may provide a low voltage of the forward start signal EVST_F to the Q node, thereby allowing the emission signal EM to be outputted.

During the reverse operation of the light emitting driving circuit, the reverse selection transistor T11B may be turned on by the reverse low voltage EVEL_B to apply the reverse start signal EVST_B to the start signal input node EVST. The reverse selection transistor T11B may provide the low voltage of the reverse start signal EVST_B to the Q node, thereby allowing the emission signal EM to be outputted.

As shown in FIG. 8, the emission control reset signal ERST may be outputted to reset the operation of the light emitting driving circuit before a frame starts. When the emission control reset signal ERST is applied at a low level, the ninth transistor T9 and the tenth transistor T10 may be turned on. The turned-on ninth transistor T9 may apply the high driving voltage EVGH to the Q node EQ. The turned-on tenth transistor T10 may apply the high driving voltage EVGH to the output terminal of the emission signal EM. Accordingly, the Q node EQ and the output terminal of the emission signal EM may be discharged to the high driving voltage EVGH.

The high driving voltage EVGH and the low driving voltage EVEL may be fixedly supplied to the light emitting driving circuit. The high driving voltage EVGH and the low driving voltage EVEL may each maintain a constant voltage regardless of forward operation and reverse operation.

The forward low voltage EVEL_F and the reverse low voltage EVEL_B may be applied according to a driving direction of the light-emitting driving circuit. In forward driving, the forward low voltage EVEL_F may be applied as a low-level voltage, and the reverse low voltage EVEL_B may be maintained at the high level. Since the illustrated driving waveform is an example of forward driving, the forward low voltage EVEL_F is shown as being applied as a low-level voltage, and the reverse low voltage EVEL_B is shown as being applied at the high level. On the other hand, in reverse driving, the reverse low voltage EVEL_B may be applied as the low-level voltage, and the forward low voltage EVEL_F may be maintained at the high level.

The clock signals ECLK1 and ECLK2 may be pulse signals having a constant period, signal magnitude, and duty ratio. The clock signals ECLK1 and ECLK2 may include a first level (e.g., low level) and a second level (e.g., high level). The clock signals ECLK1 and ECLK2 may be a signal in which the first level and the second level alternate, and one period may be defined as a combination of a duration of the first level and a duration of the second level. The first clock signal ECLK1 and the second clock signal ECLK2 may be inputted to odd-numbered stages and even-numbered stages, respectively. The number of clock signals may vary depending on a driving method of the emission driver.

The forward start signal EVST_F and the reverse start signal EVST_B are pulse signals having a preset period and magnitude. Based on one period 1H during which the clock signals ECLK1 and ECLK2 maintain a constant value, the forward start signal EVST_F or the reverse start signal EVST_B may be supplied for a duration of two periods 2H. One period 1H may be one horizontal period. In forward driving, the forward start signal EVST_F may be applied as the low-level voltage, and the reverse start signal EVST_B may be maintained at the high level. Since the illustrated driving waveform is an example of forward driving, the forward start signal EVST_F is shown as being applied as a low-level pulse, and the reverse start signal EVST_B is shown as being maintained at the high level. On the other hand, in reverse driving, the reverse start signal EVST_B may be applied as the low-level pulse, and the forward start signal EVST_F may be maintained at the high level.

As shown in voltage changes at the QB node EQB, the start signal input node EVST, the Q node EQ, and an EM node included in the light-emitting driving circuit, when the forward start signal EVST_F is inputted at the low level, an input node of the start signal EVST may begin to be charged to the low level, and simultaneously, the QB node EQB may begin to be discharged to the high level.

During a 2H period in which the forward start signal EVST_F is inputted at the low level, the start signal input node EVST may also be charged to the low level. When the forward start signal EVST_F transitions to the high level, the start signal input node EVST may be discharged to the high level.

The QB node EQB may begin to be discharged to the high level simultaneously with the charging of the start signal input node EVST to the low level, and may maintain the discharged state at the high level for a 1H period after the start signal input node EVST is discharged to the high level.

The Q node EQ and the output terminal (the EM node) of the emission signal EM may begin to be charged to the low level starting from a period following a 1H period during which the start signal input node EVST is charged to the low level, and may maintain the charged state at the low level for a 2H period until the 1H period during which the start signal input node EVST is discharged to the high level.

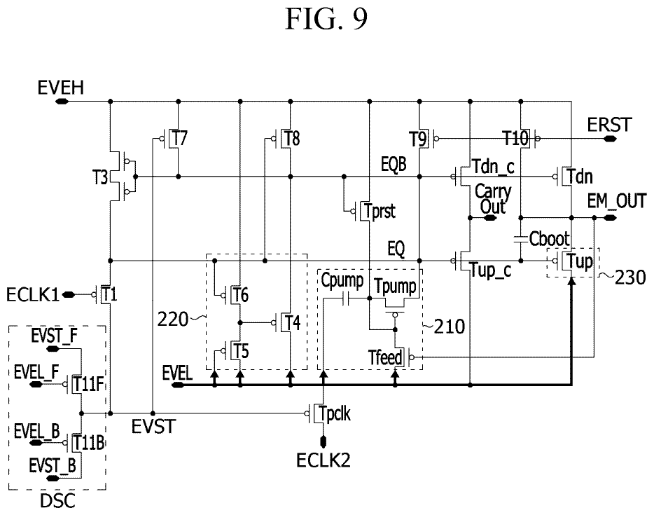

FIG. 9 is a circuit diagram illustrating a gate driving circuit supplied with a driving voltage according to an example embodiment of the present disclosure.

As shown in FIG. 9, a gate driving circuit according to an example embodiment of the present disclosure may include a plurality of transistors. The gate driving circuit shown in the drawing may correspond to any one of the plurality of stages described above.

The gate driving circuit according to an example embodiment may include a first driving voltage EVEL input terminal for being supplied with a first driving voltage EVEL. The gate driving circuit may include a second driving voltage EVEH input terminal for being supplied with a second driving voltage EVEH higher than the first driving voltage EVEL.

The potentials of the first driving voltage EVEL and the second driving voltage EVEH may be different from each other. For example, a magnitude of the potential of the first driving voltage EVEL may be lower than a magnitude of the potential of the second driving voltage EVEH.

In one embodiment, as shown in the above-described waveform diagram, the first driving voltage EVEL may be the low driving voltage EVEL. For example, the first driving voltage EVEL may be a low potential driving voltage. The second driving voltage EVEH may be the high driving voltage EVEH. For example, the second driving voltage EVEH may be a high potential driving voltage.

The gate driving circuit according to an embodiment may further include a pump part 210, an inverter part 220, and a pull-up transistor Tup.

The pump part 210, the inverter part 220, and the pull-up transistor Tup may be connected to the first driving voltage EVEL input terminal to receive the first driving voltage EVEL.

The pump part 210 may include the pump capacitor Cpump, the pump transistor Tpump, and the feed transistor Tfeed. The pump capacitor Cpump may be positioned between the Q node EQ and the first driving voltage EVEL input terminal. The pump transistor Tpump may be positioned between the pump capacitor Cpump and the Q node EQ. The feed transistor Tfeed may be connected to the gate electrode (or gate node) of the pump transistor Tpump and the first driving voltage EVEL input terminal.

The inverter part 220 may include the fourth transistor T4, the fifth transistor T5, and the sixth transistor T6. The fourth transistor T4 may be positioned between the QB node EQB and the first driving voltage EVEL input terminal. The fifth transistor T5 may be positioned between the first driving voltage EVEL input terminal and the second driving voltage EVEH input terminal. The sixth transistor T6 may be positioned between the first driving voltage EVEL input terminal and the second driving voltage EVEH input terminal.

The pull-up transistor Tup may be positioned between the output terminal of the gate driving circuit and the first driving voltage EVEL input terminal.

In one embodiment, the pump part 210, the inverter part 220, and the pull-up transistor Tup may receive the first driving voltage EVEL during operation. If the first driving voltage EVEL is not properly received, a problem may occur in a gate signal (e.g., the emission signal EM) outputted from the output terminal of the gate driving circuit.

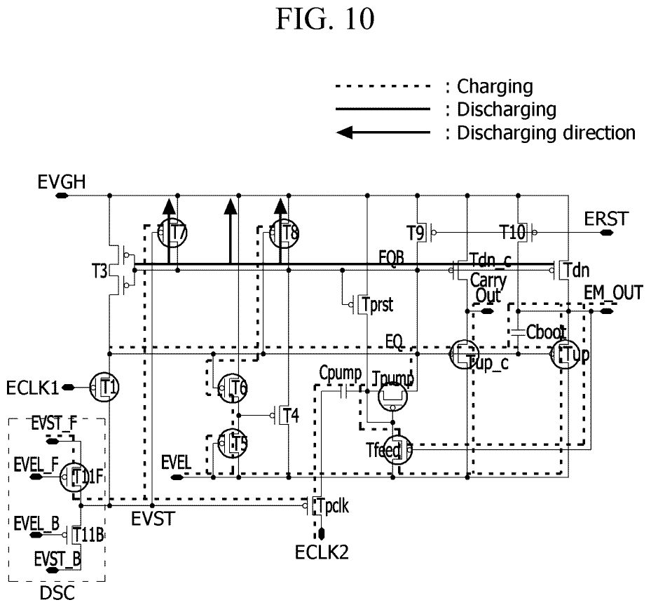

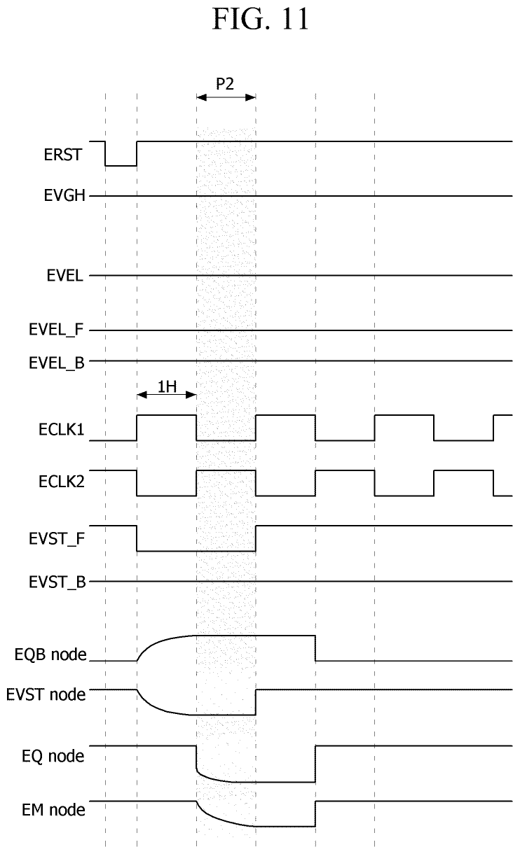

FIGS. 10 and 11 are a circuit diagram and a waveform diagram illustrating a driving method and a driving waveform of a gate driving circuit in a second section P2.

As shown in FIGS. 10 and 11, when the first clock signal ECLK1 is inputted to the low level in the second section P2, the Q node EQ may be charged to the low level, so that the pull-up transistor Tup_c for the output of the carry signal and the pull-up transistor Tup for the output of the emission signal EM may be turned on. Accordingly, the first driving voltage EVEL may be supplied through the pull-up transistor Tup_c for the output of the carry signal and the pull-up transistor Tup for the output of the emission signal EM, so that the carry signal Carry and the emission signal EM may be outputted.

The feed transistor Tfeed may be turned on by the emission signal EM at a turn-on level. When the feed transistor Tfeed is turned on, the first driving voltage EVEL may be applied to the gate node of the pump transistor Tpump. A voltage level of the first driving voltage EVEL may be a level that turns on the pump transistor Tpump.

As the pump transistor Tpump is turned on, the pump capacitor Cpump may be electrically connected to the Q node EQ. The pump capacitor Cpump may be coupled to the Q node EQ.

Here, since the clock transistor Tpclk is in a turned-on state, the Q node EQ may be boosted in synchronization with the period of the clock signals ECLK1 and ECLK2. During a period in which the emission signal EM at a turn-on level is outputted, a voltage level of the Q node EQ may be stably maintained at a level that turns on the pull-up transistor Tup. As a result, the output of the emission signal EM at the turn-on level may be stably maintained during an emission period. The emission signal EM may be outputted from the output terminal of the gate driving circuit.

The QB node EQB may be maintained in a state discharged to the high level.

As described above, as the first driving voltage EVEL is properly applied to the pump part 210, the signal EM may be normally outputted from the output terminal of the gate driving circuit.

If the first driving voltage EVEL is not properly applied to any one of the pump part 210, the inverter part 220, and the pull-up transistor Tup, a problem may occur in which the output of the signal EM becomes unstable.

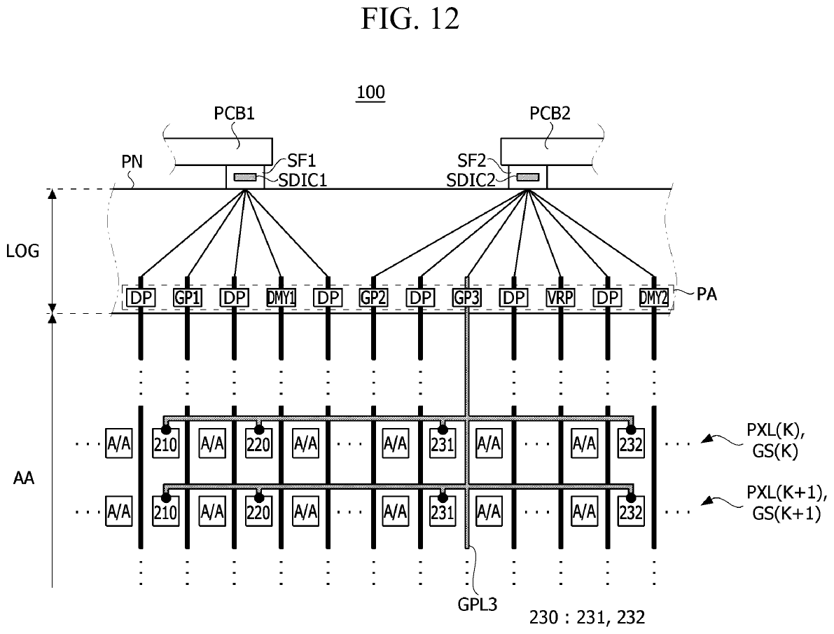

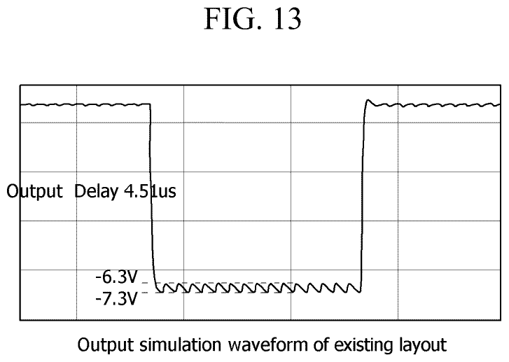

FIG. 12 is a schematic plan view illustrating a layout structure of a display device. FIG. 13 is a graph illustrating unstable signal output due to an increase in wire length.

As shown in FIG. 12, in the display device 100 according to an example embodiment of the present disclosure, COFs SF1 and SF2 on which source driver ICs SDIC1 and SDIC2 are mounted are electrically connected between corresponding printed circuit boards (PCBs) PCB1 and PCB2 and the pads of the display panel PN. The COFs SF1 and SF2 on which the source driver ICs SDIC1 and SDIC2 are mounted may be electrically connected to the pads of a pad area PA that is located in a line-on-glass (LOG) region of the display panel PN. The LOG region is a non-display area outside a display area AA of the display panel PN.

The COFs SF1 and SF2, on which the source driver ICs SDIC1 and SDIC2 are mounted, may be electrically connected to pads DP, VRP, GP1, GP2, GP3, DMY1, and DMY2 of the pad area PA and may supply a data signal, a gate signal, and a driving voltage to the display panel PN. The COFs SF1 and SF2, on which the source driver ICs SDIC1 and SDIC2 are mounted, include wires to which a gate signal is applied and wires to which power such as a driving voltage is applied.

The pad area PA may be positioned between the display panel PN and the source driver IC SDIC and may supply the data signal and the gate signal, which are transmitted from the source driver IC SDIC, to the gate driving circuit and a sub-pixel circuit A/A positioned in the display panel PN.

The plurality of sub-pixel circuits and the gate driving circuit may be arranged in the display panel PN. The gate driving circuit may include a plurality of transistors, as described above. In addition, the gate driving circuit may include the pump part 210, the inverter part 220, and the pull-up transistor 230 shown in the above-described drawings.

In one embodiment, a light-emitting element positioned in the display device 100 according to an embodiment of the present disclosure may be a light-emitting diode (LED) or a micro light-emitting diode (micro LED). When the light-emitting element is implemented as a micro LED, a size of the light-emitting element may be 100 μm or less. In the case where such a very small light-emitting element is used, if one stage including the entire gate driving circuit is positioned between the sub-pixel circuits A/A or between the pixel circuits including the sub-pixel circuits A/A, a distance between sub-pixels may become greater than a distance between the sub-pixels preferable for a desired resolution.

The gate driving circuit positioned in the display panel PN according to an embodiment of the present disclosure may include a plurality of transistors. The plurality of transistors may include any one transistor (e.g., the pump transistor Tpump) in the gate driving circuit described above, or may include a group of transistors (e.g., the pump part 210) grouped into an appropriate unit in consideration of size.

In consideration of the size of the sub-pixel circuit A/A including a very small light-emitting element, the sub-pixel circuit A/A may be positioned between the plurality of transistors. For example, one sub-pixel circuit A/A may be positioned between the pump part 210 and the inverter part 220.

The display panel PN may include a plurality of pixel lines. The plurality of pixel lines may include a Kth pixel line PXL (K). K is a natural number. The Kth pixel line PXL (K) may include the plurality of sub-pixel circuits A/A. The sub-pixel circuits positioned in the same pixel line (e.g., the Kth pixel line PXL (K)) may simultaneously receive a signal outputted from the gate driving circuit positioned in the same stage (e.g., a Kth stage GS (K)). The Kth stage GS (K) may be implemented as the gate driving circuit according to the above-described embodiment. The Kth stage GS (K) may include the pump part 210, the inverter part 220, and the pull-up transistor 230. In order for light emission of the sub-pixel circuit A/A to be properly performed, the output of the gate driving circuit that outputs a gate signal to the sub-pixel circuit A/A needs to be normally performed.

For simplicity of description, the following description will be given based on the assumption of the Kth pixel line PXL (K) and the Kth stage GS (K) that supplies a gate signal to the Kth pixel line PXL (K).

As described above, the first driving voltage may be supplied to the pump part 210, the inverter part 220, and the pull-up transistor 230.

The pad area PA may include the plurality of pads DP, VRP, GP1, GP2, GP3, DMY1, and DMY2. The plurality of pads DP, VRP, GP1, GP2, GP3, DMY1, and DMY2 may include gate pads GP1, GP2, and GP3, a plurality of dummy pads DMY1 and DMY2, a plurality of data pads DP, and the like. The pad area PA may further include a reference voltage pad VRP that supplies a reference voltage. The reference voltage may be supplied to the sub-pixel circuit.

The plurality of gate pads GP1, GP2, and GP3 may include a first gate pad GP1, a second gate pad GP2, and a third gate pad GP3. The plurality of gate pads GP1, GP2, and GP3 may serve to transmit a gate signal to the gate driving circuit. For example, the first gate pad GP1 may supply the clock signal described above. For example, the second gate pad GP2 may supply the emission control reset signal described above. For example, the third gate pad GP3 may supply the first driving voltage.

The plurality of dummy pads DMY1 and DMY2 and the plurality of data pads DP may be positioned between the plurality of gate pads GP1, GP2, and GP3.

The plurality of data pads DP may be positioned between the plurality of gate pads GP1, GP2, and GP3. In consideration of the characteristics of the display device according to an embodiment in which the sub-pixel circuit A/A is positioned between the plurality of transistors included in the gate driving circuit due to the small size of the light-emitting element, the data pad DP may be positioned between the plurality of gate pads GP1, GP2, and GP3. For example, the data pad DP and the gate pads GP1, GP2, and GP3 may be alternately arranged. However, the arrangement is not limited thereto, and the reference voltage pad VRP that supplies the reference voltage to the sub-pixel circuit may be positioned between the plurality of data pads DP.

The plurality of dummy pads DMY1 and DMY2 may be provided to achieve balance with block units of the sub-pixel circuits A/A and/or the pump part 210 (or the inverter part 220) arranged in a matrix form in the display panel PN. For example, if no pad is present at a location where a first dummy pad DMY1 is positioned, a problem may occur in the balance of wires connected in the LOG region. Accordingly, the dummy pads DMY1 and DMY2 may be utilized at such locations in consideration of uniformity and balance with other wires. Therefore, locations where the dummy pads DMY1 and DMY2 are positioned may not be the locations to which a specific signal (e.g., a data signal or a gate signal) is to be supplied by design.

As shown in the display panel PN, the pull-up transistor 230 may be positioned in a plurality of regions. Compared to the block size of the sub-pixel circuit A/A formed according to the light-emitting elements having a small size, the size of the pull-up transistor 230 that is directly involved in the output of the gate driving circuit may be large. Accordingly, in the display device 100 according to an embodiment of the present disclosure, the pull-up transistor 230 may be distributed across the plurality of regions according to the design.

For example, the pull-up transistor 230 may include a first pull-up transistor 231 positioned between the plurality of sub-pixel circuits A/A and a second pull-up transistor 232 positioned between the plurality of sub-pixel circuits A/A. Although the first pull-up transistor 231 and the second pull-up transistor 232 are separately positioned in two regions in the display panel PN, they may be interpreted as a single transistor 230 in a circuit diagram. For example, the first pull-up transistor 231 and the second pull-up transistor 232 may share a gate electrode and source/drain electrodes. The pull-up transistor 230, including the first pull-up transistor 231 and the second pull-up transistor 232, may have only one gate electrode and one source/drain electrode. It should be noted that this is different from a case in which multiple transistors are formed, each having their own gate electrode and source/drain electrodes.

As described above, the first driving voltage may be supplied to the pump part 210, the inverter part 220, and the pull-up transistor 230.

The first driving voltage was supplied to the pump part 210, the inverter part 220, and the pull-up transistor 230 through one pad (e.g., the third gate pad GP3). For example, a third wire GPL3 connected to the third gate pad GP3 was connected to all of the first pull-up transistor 231, the second pull-up transistor 232, the pump part 210, and the inverter part 220.

As such, when all of these components are connected using one gate pad wire (e.g., the third wire GPL3), the wire length may increase, which may lead to an increase in wire resistance and the like. As a result, IR drop phenomena may be exacerbated. This may ultimately affect the output characteristics of the gate driving circuit and cause problems in the operational reliability of the light-emitting element.

As shown in FIG. 13, when a signal and/or voltage is supplied using a single wire, a problem may occur in which the output waveform of the gate driving circuit oscillates between −6.3 V and −7.3 V.

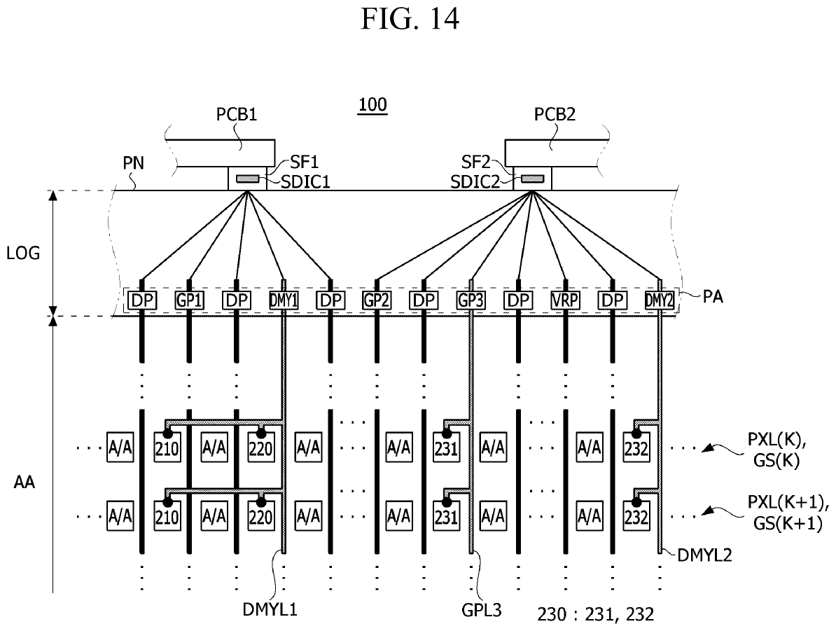

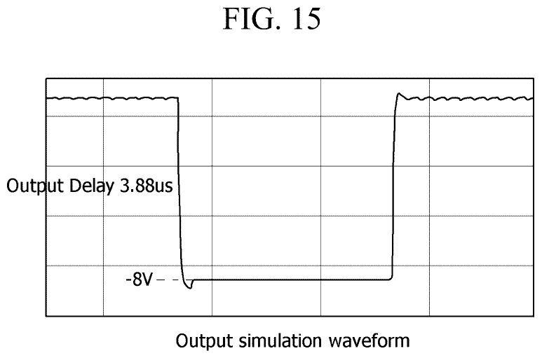

FIG. 14 is a schematic plan view illustrating a layout structure of a display device according to an example embodiment of the present disclosure. FIG. 15 is a graph illustrating stable signal output resulting from adjustment of wire length. The same reference numerals are assigned to components that perform substantially the same functions as those in the above-described drawings, and redundant descriptions thereof will be omitted.

As shown in FIG. 14, a first COF SF1 on which a first source driver IC SDIC1 is mounted may be electrically connected to a first wire DMYL1 through the first dummy pad DMY1. A second COF SF2 on which a second source driver IC SCIC2 is mounted may be electrically connected to a second wire DMYL2 through a second dummy pad DMY2 and may be electrically connected to the third wire GPL3 through the third gate pad GP3.

The second gate pad GP2 may be positioned between the first dummy pad DMY1 and the second dummy pad DMY2. The third gate pad GP3 may be positioned between the first dummy pad DMY1 and the second dummy pad DMY2. The data pad DP may be positioned between the second gate pad GP2 and the third gate pad GP3.

The third gate pad GP3 may be connected to the third wire GPL3. The first dummy pad DMY1 may be connected to the first wire DMYL1. The second dummy pad DMY2 may be connected to the second wire DMYL2.

In one embodiment, the first dummy pad DMY1, the second dummy pad DMY2, and the third gate pad GP3 may supply the first driving voltage.

The display device 100 according to an embodiment of the present disclosure may reduce resistance caused by an increase in wire length. Through this, the output of the gate driving circuit may be stabilized.

To this end, the first dummy pad DMY1 and the second dummy pad DMY2 may be connected to the plurality of transistors positioned in the gate driving circuit. For example, the first dummy pad DMY1 may be connected to the pump part 210 and the inverter part 220. For example, the second dummy pad DMY2 may be connected to the second pull-up transistor 232.

The display device 100 according to an embodiment of the present disclosure may supply a signal by utilizing the dummy pads DMY1 and DMY2, which are arranged to achieve balance without supplying a specific signal. The wire DMYL1 connected to the first dummy pad DMY1 and the wire DMYL2 connected to the second dummy pad DMY2 may have the same wire length and resistance. In addition, each of these wires DMYL1 and DMYL2 may have substantially the same length and resistance as the third wire GPL3. The first dummy pad DMY1 and the second dummy pad DMY2 may be interpreted as a first power pad and a second power pad, respectively. The third gate pad GP3 may be interpreted as a third power pad. The first driving voltage EVEL having the same voltage level may be applied to the first dummy pad DMY1, the second dummy pad DMY2, and the third gate pad GP3. The first dummy pad DMY1, the second dummy pad DMY2, and the third gate pad GP3 may be electrically connected to an EVEL output terminal at which the first driving voltage EVEL is outputted from a power IC.

When the wires DMYL1 and DMYL2 connected to the dummy pads DMY1 and DMY2 are utilized, the wire length may be reduced, thereby improving the output characteristics of the gate driving circuit. Accordingly, the operational reliability of the display device 100 may be improved and low power driving may be achieved. In addition, by removing a portion of the third wire GPL3 that has been extended to be connected to the pump part 210, the inverter part 220, and/or the second pull-up transistor 232, an effective design area within the display panel PN may be increased.

The first wire DMYL1 may be connected to the pump part 210, e.g., to the feed transistor Tfeed shown in FIG. 9. As shown in FIG. 9, the feed transistor Tfeed includes a first electrode connected to the gate electrode and first electrode of the pump transistor Tpump, a gate electrode connected to the output terminal of the emission signal EM_OUT, and a second electrode connected to the first driving voltage EVEL input terminal.

The first wire DMYL1 may be connected to the inverter part 220, e.g., the fourth transistor T4 and the fifth transistor T5 shown in FIG. 9. As shown in FIG. 9, the fourth transistor T4 includes a first electrode connected to the QB node EQB, a gate electrode connected to the first electrode of the fifth transistor T5 and the second electrode of the sixth transistor T6, and a second electrode connected to the first driving voltage EVEL input terminal. As shown in FIG. 9, the fifth transistor T5 includes a first electrode connected to the gate electrode of the fourth transistor T4 and the second electrode of the sixth transistor T6, and a gate electrode and a second electrode connected to the first driving voltage EVEL input terminal, as shown in FIG. 9.

The second wire DMYL2 may be connected to the second pull-up transistor 232. The third wire GPL3 may be connected to the first pull-up transistor 231. In the gate driving circuit shown in FIG. 9, each of the first and second pull-up transistors 231 and 232 may include a first electrode connected to an output terminal from which the emission signal EM_OUT is outputted, a gate electrode connected to the Q node EQ, and a second electrode connected to a wire to which the first driving voltage EVEL is applied.

In one embodiment, the first wire DMYL1, the second wire DMYL2, and the third wire GPL3 have substantially the same length and resistance.

As shown in FIG. 15, when a signal and/or voltage is supplied by utilizing the dummy pad and wire, it may be confirmed that the output waveform of the gate driving circuit is stable at −8V.

According to one or more embodiments of the present disclosure, the display apparatus may be applied to mobile apparatuses, video phones, smart watches, watch phones, wearable apparatus, foldable apparatus, rollable apparatus, bendable apparatus, flexible apparatus, curved apparatus, sliding apparatus, variable apparatus, electronic organizer, electronic books, portable multimedia players (PMPs), personal digital assistants (PDAs), MP3 players, mobile medical apparatuses, desktop PCs, laptop PCs, netbook computers, workstations, navigations, vehicle navigations, vehicle display apparatuses, vehicle apparatuses, theater apparatuses, theater display apparatuses, televisions, wallpaper apparatuses, signage apparatuses, game apparatuses, laptops, monitors, cameras, camcorders, and home appliances, etc. Additionally, the display apparatus according to one or more embodiments of the present disclosure may be applied to organic light emitting lighting apparatuses or inorganic light emitting lighting apparatuses.

The objects to be achieved by the present disclosure, the means for achieving the objects, and effects of the present disclosure described above do not specify essential features of the claims, and thus, the scope of the claims is not limited to the disclosure of the present disclosure.

Although various example embodiments of the present disclosure have been described in more detail with reference to the accompanying drawings, the present disclosure is not limited thereto and may be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described example embodiments are illustrative in all aspects and do not limit the present disclosure.

What is claimed is:

1. A display panel, comprising:
a first power pad, a second power pad, and a third power pad configured to receive a first driving voltage;
a first wire connected to the first power pad;
a second wire connected to the second power pad;
a third wire connected to the third power pad;
at least one transistor connected to the first wire;
at least one transistor connected to the second wire; and
at least one transistor connected to the third wire,
wherein the first wire, the second wire, and the third wire have the same length.

2. The display panel of claim 1, further comprising:
a plurality of sub-pixel circuits,
wherein the at least one transistor connected to the first wire, the at least one transistor connected to the second wire, and the at least one transistor connected to the third wire are each positioned between adjacent sub-pixel circuits, among the plurality of sub-pixel circuits, in a first direction of the display panel.

3. The display panel of claim 2, further comprising:
gate wires connected to the sub-pixel circuits, and
a gate driving circuit connected to the gate wires and configured to supply an emission signal to the gate wires,
wherein the gate driving circuit includes the at least one transistor connected to the first wire, the at least one transistor connected to the second wire, and the at least one transistor connected to the third wire.

4. The display panel of claim 3, wherein the at least one transistor connected to the first wire includes a feed transistor having a first electrode, a gate electrode connected to an output terminal of the emission signal, and a second electrode connected to a first driving voltage wire configured to receive the first driving voltage.

5. The display panel of claim 4, wherein the at least one transistor connected to the first wire is connected to an inverter of the gate driving circuit.

6. The display panel of claim 5, wherein:
the inverter includes a fourth transistor, a fifth transistor, and a sixth transistor,
the fourth transistor has a first electrode, a gate electrode, and a second electrode connected to the first driving voltage wire, and
the fifth transistor has a first electrode connected to the gate electrode of the fourth transistor, and a gate electrode and a second electrode connected to the first driving voltage wire.

7. The display panel of claim 4, wherein:
the at least one transistor connected to the third wire includes a first pull-up transistor of the gate driving circuit,
the at least one transistor connected to the second wire includes a second pull-up transistor of the gate driving circuit, and
each of the first and second pull-up transistors has a first electrode connected to an output terminal from which the emission signal is outputted, a gate electrode connected to a Q node, and a second electrode connected to the first driving voltage wire.

8. The display panel of claim 7, wherein the first pull-up transistor and the second pull-up transistor share a gate electrode and source/drain electrodes.

9. The display panel of claim 1, further comprising:
a plurality of data pads configured to receive a data signal,
wherein each of the first power pad, the second power pad, and the third power pad is positioned between adjacent data pads, among the plurality of data pads, in a first direction of the display panel.

10. A display device, comprising:
a display panel having a pad area including a first power pad, a second power pad, and a third power pad, a first wire connected to the first power pad, a second wire connected to the second power pad, a third wire connected to the third power pad, at least one transistor connected to the first wire, at least one transistor connected to the second wire, and at least one transistor connected to the third wire; and
a circuit configured to supply a first driving voltage to the first power pad, the second power pad, and the third power pad,
wherein the first wire, the second wire, and the third wire have the same length.

11. The display device of claim 10, wherein the display panel further includes a plurality of sub-pixel circuits, and
wherein the at least one transistor connected to the first wire, the at least one transistor connected to the second wire, and the at least one transistor connected to the third wire are each positioned between adjacent sub-pixel circuits, among the plurality of sub-pixel circuits, in a first direction of the display panel.

12. The display device of claim 11, wherein the display panel further includes:
gate wires connected to the sub-pixel circuits; and
a gate driving circuit connected to the gate wires and configured to supply an emission signal to the gate wires, and
wherein the gate driving circuit includes the at least one transistor connected to the first wire, the at least one transistor connected to the second wire, and the at least one transistor connected to the third wire.

13. The display device of claim 12, wherein the at least one transistor connected to the first wire includes a feed transistor having a first electrode, a gate electrode connected to an output terminal of the emission signal, and a second electrode connected to a first driving voltage wire configured to receive the first driving voltage.

14. The display device of claim 13, wherein:
the at least one transistor connected to the first wire is connected to an inverter of the gate driving circuit,
the inverter includes a fourth transistor, a fifth transistor, and a sixth transistor,
the fourth transistor has a first electrode, a gate electrode, and a second electrode connected to the first driving voltage wire, and
the fifth transistor has a first electrode connected to the gate electrode of the fourth transistor, and a gate electrode and a second electrode connected to the first driving voltage wire.

15. The display device of claim 13, wherein:
the at least one transistor connected to the third wire includes a first pull-up transistor of the gate driving circuit,
the at least one transistor connected to the second wire includes a second pull-up transistor of the gate driving circuit, and
each of the first and second pull-up transistors has a first electrode connected to an output terminal from which the emission signal is outputted, a gate electrode connected to a Q node, and a second electrode connected to the first driving voltage wire.

16. The display device of claim 10, wherein:
the display panel further includes a plurality of data pads configured to receive a data signal,
the circuit includes a data driving circuit configured to output the data signal, and
each of the first power pad, the second power pad, and the third power pad is positioned between adjacent data pads, among the plurality of data pads, in a first direction of the display panel.

17. The display device of claim 16, wherein the data driving circuit includes:
a first chip-on-film electrically connected to the first power pad; and
a second chip-on-film electrically connected to the second power pad and the third power pad.

18. The display device of claim 10, wherein the first power pad is a first dummy pad, the second power pad is a second dummy pad, and the third power pad is a gate pad,
wherein the gate pad is configured to transmit a gate signal to a gate driving circuit, the gate driving circuit including a pump part, an inverter part, a first pull-up transistor, and a second pull-up transistor.

19. The display device of claim 18, wherein the first wire is connected to the pump part and the inverter part of the gate driving circuit, the second wire is connected to the second pull-up transistor and the third wire is connected to the first pull-up transistor.
